(19) United States
(12) Patent Application Publication
(10) Pub. No.: US 2007/0134509 A1
(43) Pub. Date: Jun. 14, 2007

(54) COPPER INTERCONNECTION STRUCTURE AND METHOD FOR FORMING SAME

(76) Inventor: Ji Ho Hong, Seoul (KR)

Correspondence Address: SHERR & NOURSE, PLLC, 620 HERNDON PARKWAY, SUITE 200, HERNDON, VA, 20170, US

(21) Appl. No.: 11/566,010

(22) Filed: Dec. 1, 2006

(30) Foreign Application Priority Data
Dec. 9, 2005 (KR) 10-2005-0120589

(51) Int. Cl. B32B 15/20; C23C 28/00; C25D 5/10

(52) U.S. Cl. 428/671; 428/674; 205/183; 205/170

(57) ABSTRACT

A method for forming a Copper interconnection may include at least one of the following. Forming an insulating layer over a semiconductor substrate. Electroplating a barrier metal layer over a insulating layer, with the barrier metal layer having a reduction potential higher than Copper. Electroplating a Copper layer over a barrier metal layer. A barrier metal layer may include Ruthenium (Ru), Silver (Ag), Palladium (Pd), Platinum (Pt) or Gold (Au).

The present application claims priority under 35 U.S.C. 119 and 35 U.S.C. 365 to Korean Patent Application No. 10-2005-0120589 (filed on Dec. 9, 2005), which is hereby incorporated by reference in its entirety.

### BACKGROUND

Copper interconnections may be used to improve operational speed of a semiconductor device. Copper interconnections may be formed through electroplating and may be patterned using a damascene method. A Copper interconnection may be formed by first sequentially forming a barrier metal layer and a Copper seed layer using chemical vapor deposition (CVD) or physical vapor deposition (PVD). A Copper layer may be formed to fill a metal interconnection area over a Copper seed layer through electroplating. A Copper seed layer may be used to improve interconnection reliability of a semiconductor device by enhancing the uniformity of the Copper layer and interfacial properties.

A method of forming Copper interconnections may include depositing a barrier metal layer and forming a Copper seed layer over the barrier metal layer through CVD or PVD. This process may become relatively complex, thereby increasing the cost of forming a Copper interconnection.

### SUMMARY

Embodiments relate to manufacturing a semiconductor device. In embodiments, a Copper interconnection structure may be formed by a multi-step electroplating process. In embodiments, a Copper interconnection may be formed through a relatively simple process, which may minimize costs.

In embodiments, a method of forming a Copper interconnection may include at least one of the following steps: A step of forming an insulating layer over a semiconductor substrate. A step of forming a barrier metal layer over an insulating layer through electroplating. Electroplating may use a material that has a reduction potential higher than Copper. A step of forming a Copper layer over a barrier metal layer through electroplating.

In embodiments, a Copper interconnection structure may include at least one of the following: An insulating layer formed over a semiconductor substrate. A barrier metal layer electroplated on an insulating layer with a material that has a reduction potential higher than Copper. A Copper layer electroplated on the barrier metal layer.

### BRIEF DESCRIPTION OF THE DRAWINGS

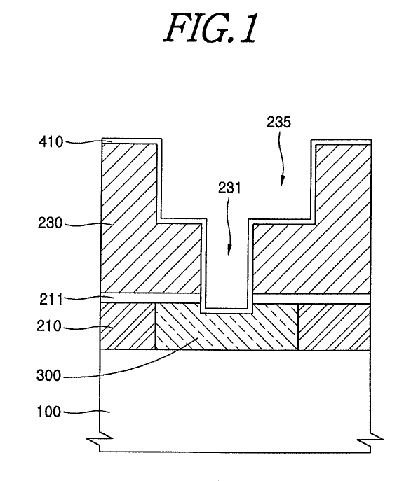

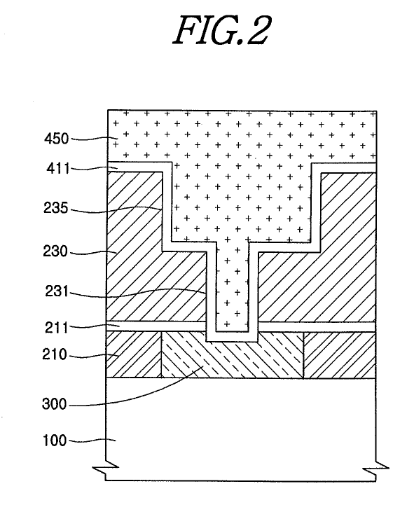

Example FIGS. 1 and 2 illustrate schematic cross-sectional views of a Copper interconnection structure and a method of forming a Copper interconnection structure, in accordance with embodiments.

### DETAILED DESCRIPTION

In embodiments, a Copper layer may be formed by electroplating a barrier metal layer, without forming a Copper seed layer.

When a Copper layer is formed over a barrier metal layer by electroplating, it may be difficult to control the uniformity of the Copper, especially if the resistivity of the barrier metal layer is large. Further, the interfacial adhesion between a barrier metal layer and an electroplated Copper layer may deteriorate, which may have an adverse effect on interconnection reliability. A Copper seed layer may be formed to control the uniformity of Copper and/or prevent deterioration of interfacial adhesion.

In embodiments, a Copper interconnection may be formed without forming a Copper seed layer, which may improve interfacial adhesion between a barrier metal layer and an electroplated Copper layer. Formation of a Copper interconnection may include electroplating a barrier metal layer with a Copper layer. There may be a reduction potential difference between a Copper layer and a barrier metal layer.

In embodiments, an initial barrier metal layer may be formed prior to electroplating a barrier metal layer. An initial barrier metal layer may be formed using chemical vapor deposition (CVD), physical vapor deposition (PVD), or atomic layer deposition (ALD). An initial barrier metal layer may include material that is substantially the same or identical to an electroplated barrier metal layer. A barrier metal layer may have a standard reduction potential higher than Copper. A barrier metal layer may be formed by electroplating process, prior to formation of a Copper layer. In embodiments, a barrier metal layer and a Copper layer may be formed in a multi-step electroplating process. A multi-step electroplating process may improve interfacial adhesion between a barrier metal layer and a Copper layer.

Example FIGS. 1 and 2 illustrate schematic cross-sectional views of a Copper interconnection structure and a method of forming a Copper interconnection structure, in accordance with embodiments. As illustrated in FIG. 1, first insulating layer 230 may be formed over semiconductor substrate 100. Via hole 231 and trench 235 may be formed in first insulating layer 230, so that a Copper interconnection may be patterned using a damascene process.

Under first insulating layer 230, a conductive pattern (e.g. first line 300 or a contact) may be formed. Second insulating layer 210 may be formed under first insulating layer 230, which may insulate a conductive pattern. Barrier insulating layer 211 may be formed at the interface between second insulating layer 210 and first insulating layer 230. Barrier insulating layer 211 may prevent a conductive pattern (e.g. such as first line 300) from being damaged during a selective etching process (e.g. during formation of via hole 231 and trench 235). In embodiments, other devices and/or insulating layers may be formed between second insulating layer 210 and substrate 100.

After via hole 231 and trench 235 are formed in first insulating layer 230, initial barrier metal layer 410 may be formed. Initial barrier metal layer 410 may serve as a seed layer for forming a barrier metal layer. A barrier metal layer may be formed through an electroplating process (e.g. using CVD, PVD or ALD). Initial barrier metal layer 410 may include a metal material substantially the same or identical to a barrier metal layer to be formed over initial barrier metal layer 410.

Initial barrier metal layer 410 and a barrier metal layer may include a metal material having a standard reduction potential higher than Copper. For example, initial barrier metal layer 410 may include metals such as Ruthenium (Ru), Silver (Ag), Palladium (Pd), Platinum (Pt) or Gold (Au), which have a standard reduction potential higher than Copper.

Reduction potentials may be measured at the following: At 0.455 V when Ru²⁺ is combined with two electrons and reduced to Ru. At 0.7996 V when Ag⁺ is combined with one electron and reduced to Ag. At 0.951 V when Pd²⁺ is combined with two electrons and reduced to Pd. At 1.18 V when Pt³⁺ is combined with three electrons and reduced to Pt. At 1.498 V when Au³⁺ is combined with three electrons and reduced to Au.

The reduction potential of Ruthenium (Ru), Silver (Ag), Palladium (Pd), Platinum (Pt) or Gold (Au) may be higher than a reduction potential of Copper. Reduction potential of Copper may be measured at 0.337 V when Cu²⁺ is combined with two electrons and reduced to Cu. In embodiments, a barrier metal layer may be formed by electroplating an electrolyte of Copper and another metal (e.g. Ruthenium, Silver, Palladium, Platinum, or Gold). A barrier metal layer including a metal other than Copper may be formed prior to formation of a Copper layer.

Ruthenium may be used as a material for initial barrier metal layer 410. Ruthenium may be a good diffusion barrier material with respect to Copper. Ruthenium may have a relatively large interfacial adhesion with respect to Copper.

As illustrated in FIG. 2, barrier metal layer 411 may be formed over initial barrier metal layer 410 by electroplating. Since first electroplated barrier metal layer 411 includes material substantially the same or identical to initial barrier metal layer 410, there may not be an interface between first electroplated barrier metal layer 411 and initial barrier metal layer 410. First electroplated barrier metal layer 411 and initial barrier metal layer 410 may not be distinguishable from each other and may function as a single continuous layer.

Copper layer 450 may be formed over barrier metal layer 411 through electroplating to fill via hole 231 and trench 235. In embodiments, first electroplated barrier metal layer 411 and Copper layer 450 may be electroplated using the same electroplating method, which may increase interfacial adhesion. Increased interfacial adhesion may cause Copper layer 450 to have improved interconnection reliability.

In embodiments, an interconnection structure including a barrier metal layer and a Cu layer may be formed with a multi-step electroplating process. Since an interconnection structure may be formed without forming a Copper seed layer, the process of forming an interconnection may be simplified and/or manufacturing costs may be reduced.

In embodiments, a barrier metal layer and a Copper layer may be formed using the same electroplating method. By using the same electroplating method, interfacial adhesion may be improved, in accordance with embodiments. In embodiments, an interconnection including a Copper layer with improved interconnection reliability may increase semiconductor manufacturing yield and/or may improve performance.

It will be apparent to those skilled in the art that various modifications and variations can be made to embodiments. Thus, it is intended that embodiments cover modifications and variations thereof within the scope of the appended claims.

What is claimed is:

1. A method comprising:
forming an insulating layer over a semiconductor substrate;
electroplating a barrier metal layer over the insulating layer, wherein the material of the barrier metal layer has a reduction potential different than Copper; and
electroplating a Copper layer over the barrier metal layer.

2. The method of claim 1, wherein the material comprised in the barrier metal layer has a reduction potential higher than Copper.

3. The method of claim 1, wherein the barrier metal layer comprises at least one of:
Ruthenium;
Silver;
Palladium;
Platinum; and
Gold.

4. The method of claim 1, comprising the step of:
prior to said electroplating the barrier metal layer, forming an initial barrier metal layer.

5. The method of claim 4, wherein the initial barrier metal layer serves as a seed layer of the barrier metal layer.

6. The method of claim 4, wherein the initial barrier metal layer comprises a material substantially the same as a material of the barrier metal layer.

7. The method of claim 4, wherein the initial barrier metal layer is formed by at least one of:
chemical vapor deposition;
physical vapor deposition; and
atomic layer deposition.

8. The method of claim 1, wherein said electroplating the barrier metal layer and said electroplating the Copper layer use the same electroplating process.

9. A apparatus comprising:
an insulating layer formed over a semiconductor substrate;
a barrier metal layer electroplated over the insulating layer, wherein the barrier metal layer comprises a material having a reduction potential different than Copper; and
a Copper layer electroplated over the barrier metal layer.

10. The apparatus of claim 9, wherein the barrier metal layer comprises a material having a reduction potential higher than Copper.

11. The apparatus of claim 9, wherein the barrier metal layer comprises at least one of:
Ruthenium;
Silver;
Palladium;
Platinum; and
Gold.

12. The apparatus of claim 9, comprising an initial barrier metal layer.

13. The apparatus of claim 12, wherein the initial barrier metal layer serves as a seed layer of the barrier metal layer.

14. The apparatus of claim 12, wherein the initial barrier metal layer comprises a material substantially the same as the material of the barrier metal layer.

15. The apparatus of claim 12, wherein the initial barrier metal layer is formed by at least one of:
chemical vapor deposition;
physical vapor deposition; and
atomic layering deposition.
